(19) United States
(12) Patent Application Publication
(10) Pub. No.: US 2006/0048820 A1
(43) Pub. Date: Mar. 9, 2006

(54) Proportioning system

(76) Inventors: Joseph D. Horner, Lilburn, GA (US); Kevin L. Clerk, Dacula, GA (US)

Correspondence Address: BRYAN W. BOCKHOP, ESQ., 2375 MOSSY BRANCH DR., SNELLVILLE, GA, 30078, US

(21) Appl. No.: 10/937,481

(22) Filed: Sep. 9, 2004

(51) Int. Cl. F16K 27/12

(52) U.S. Cl. 137/382

(57) ABSTRACT

A proportioning system includes a cutoff valve, a three-way valve, a check valve and an eductor. The cutoff valve has a cutoff intake port and a cutoff discharge port. The cutoff valve is capable of receiving a carrier fluid from a carrier fluid source and selectively discharging the carrier fluid or inhibiting carrier fluid flow. The three-way valve is capable of receiving a first active fluid and a second active fluid and is capable of selectively discharging a selected one of the first active fluid and the second active fluid, or inhibiting flow from of both the first active fluid and the second active fluid. The eductor is capable of receiving an active fluid when the carrier fluid is passing through the eductor so as to mix the active fluid with the carrier fluid.

### BACKGROUND OF THE INVENTION

1. Field of the Invention

The present invention relates to chemical mixing systems and, more specifically, to a system proportioning chemicals.

2. Description of the Prior Art

Floor cleaning and sanitation is critical in such industries as food service and production. One method of floor cleaning and sanitation includes cleaning the floor with a mop and a bucket filled with a detergent/water mixture. The floor is then rinsed with water, which is subsequently mopped up and disposed in the bucket. A sanitizer/water mixture is then applied with the mop to kill remaining microbes. This method is time consuming, strenuous for large floor surfaces and introduces the possibility of cross-contamination between the steps involved when the same mop is used for each step.

Typical operations, such as supermarket meat cutting facilities, employ central chemical proportioning systems to provide cleaning chemicals to users. Such systems include a detergent input, a sanitizer input, a water-only bypass and an output that is connectable to a hose. A plurality of valves allows a user to select between various combinations being delivered to the hose for subsequent spraying on the floor, these include: detergent/water (for cleaning), water only (for rinsing) and sanitizer/water (for sanitizing).

Typically, the user initially applies the water/detergent combination through a foaming wand coupled to the hose. The user then turns off the detergent/water feed from the proportioning system, scrubs the floor with a stiff-bristle broom and then resets the proportioning system for rinsing with water. At this point, the user has to replace the foaming wand with a spray nozzle, similar to a typical garden spray nozzle. The user then rinses with water, driving the foam into a floor drain. Next the user resets the proportioning system to receive the sanitizer/water combination and applies the sanitizer to the floor.

Proportioning is the process where active fluids are mixed with carrier fluids. For example, typical floor cleaning systems use water as a carrier fluid and solvent, into which is proportioned such active fluids as cleaners (such as detergents) and sanitizers. A prior art proportioning system is shown in FIG. 1, in which a cleaner 12 is fed through a check valve 18 into a first eductor 20, a sanitizer is fed through a check valve 22 into a second eductor 24. The fist eductor 20 receives water from a water source 16 through a first valve 26 and the second eductor receives water from the water source 16 through a second valve 30. Both the first eductor 20 and the second eductor 24 feed into a discharge 32, which is also capable of receiving water directly from the water source 16 through a third valve 28. To ensure that the correct mixture is delivered to the discharge 32, the user must ensure the each of the first valve 26, the second valve 30 and the third valve 28 are set at the correct state to deliver the correct mixture of fluids. Because of the complexity of the valve settings required by this type of system, fluid mixing mistakes are often made by users. Also, this system is relatively costly to produce because of the number of components required.

Therefore, there is a need for a proportioning system that reduces the likelihood of an incorrect mixture being delivered to the discharge. There is also a need for a proportioning system that uses relatively fewer components, thereby reducing the cost of the system.

### SUMMARY OF THE INVENTION

The disadvantages of the prior art are overcome by the present invention which, in one aspect, is a proportioning system that includes a cutoff valve, a three-way valve, a check valve and an eductor. The cutoff valve has a cutoff intake port and a cutoff discharge port. The cutoff valve is capable of receiving a carrier fluid from a carrier fluid source and selectively discharging the carrier fluid through the cutoff discharge port. The cutoff valve is also capable of inhibiting carrier fluid flow from the cutoff intake port to the cutoff discharge port. The three-way valve has a first intake port, a second intake port and a first discharge port. The three-way valve is capable of receiving a first active fluid through the first intake port and a second active fluid through the second intake port and is capable of selectively discharging a selected one of the first active fluid and the second active fluid through the first discharge port. The three-way valve is also capable of inhibiting flow from both the first active fluid and the second active fluid to the first discharge port. The check valve is in fluid communication with the first discharge port. The eductor has an eductor intake port, an eductor suction port and an eductor discharge port. The eductor suction port is in fluid communication with the check valve. The eductor intake port is in fluid communication with the cutoff discharge port. The eductor is capable of receiving an active fluid from the check valve through the suction port when the carrier fluid is passing from the eductor intake port to the eductor discharge port so as to mix the active fluid with the carrier fluid.

The invention also includes a method of proportioning fluids in which a selected one of a first active fluid source and a second active fluid source is fluidly coupled to a first discharge port. The selected one of the first active fluid and the second active fluid is educted into a stream of a carrier fluid so as to cause mixing of the carrier fluid and the selected one of the first active fluid and the second active fluid, thereby forming a mixed fluid. The mixed fluid is discharged.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of a prior art proportioning device.

FIG. 2 is a schematic diagram of an embodiment of the invention.

FIG. 3A is a front plan view of illustrative embodiment of the invention.

FIG. 3B is a side plan view of the embodiment shown in FIG. 3A.

FIG. 4 is a conceptional drawing of one embodiment in use.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

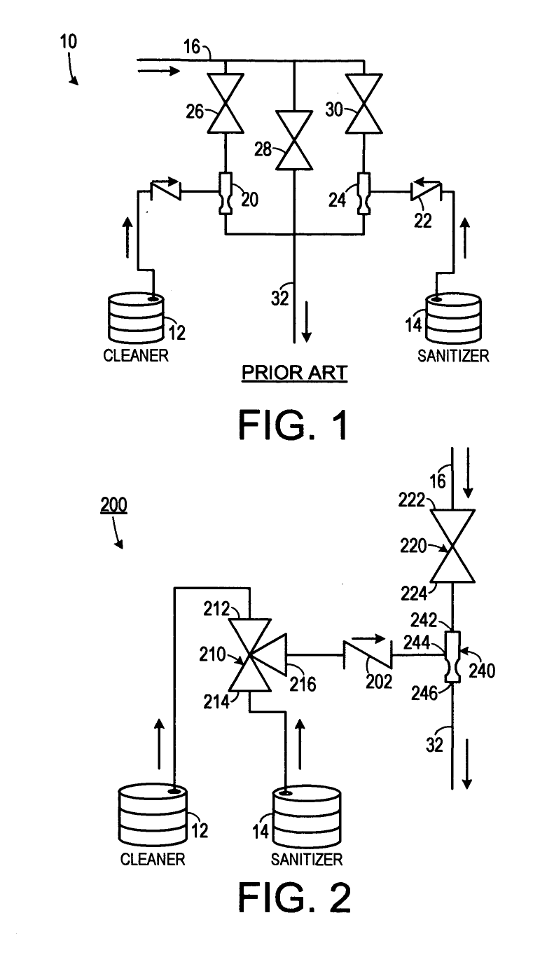

As shown in FIG. 1, one illustrative embodiment of the invention is a proportioning system 200 that includes a cutoff valve 220, a three-way valve 210, a check valve 202 and an eductor 240. The cutoff valve 220, such as a ball valve, has a cutoff intake port 222 and a cutoff discharge port 224. The cutoff valve 220 receives water, or some other carrier fluid, from a carrier fluid source 16 (such as a water hose) and discharges the water through the cutoff discharge port 224. The cutoff valve 220 is also capable of cutting off, or otherwise inhibiting water flow to the cutoff discharge port 224. One example of a suitable cutoff valve 220 is the Shut Off Trim Valve available from Apollo International Corporation.

The three-way valve 210 has a first intake port 212, a second intake port 214 and a first discharge port 216. The three-way valve 210 receives a first active fluid, such as a cleaning solution, from a first active fluid reservoir 12 through the first intake port 212 and a second active fluid, such as a sanitizer, from a second active fluid reservoir 14 through the second intake port 214. The three-way valve 210 discharges a selected one of the first active fluid and the second active fluid through the first discharge port 216. The three-way valve 210 is also capable of inhibiting flow from of both the first active fluid and the second active fluid to the first discharge port 216. The check valve 202 is in fluid communication with the first discharge port 216 and substantially allows fluid flow in one direction (the direction of the arrow).

To proportion fluids, the system 200 fluidly couples a selected one of the first active fluid source 12 and the second active fluid source 14 to the first discharge port 216. The selected one of the first active fluid and the second active fluid is educted into a stream of the carrier fluid so as to cause mixing of the carrier fluid and the selected one of the first active fluid and the second active fluid, thereby forming a mixed fluid. The mixed fluid is then discharged. If neither of the active fluids is selected, then only the carrier fluid is discharged.

The eductor 240 has an eductor intake port 242, an eductor suction port 244 and an eductor discharge port 246. The eductor suction port 244 is in fluid communication with the check valve 202. The eductor intake port 242 is in fluid communication with the cutoff discharge port 224. As water flows through the eductor 240, the active fluid from the check valve 202 is drawn through the suction port 244, mixed with the water and the mixture of the active fluid and water is discharged through the discharge port 246 into a discharge hose 32 for subsequent use. Liquid Eductors are venturi jet devices that use pressurized liquid to entrain, mix and pump other liquids, slurries, gases or dry solids. Eductors consist of two basic parts, the motive nozzle, which converts the pressure energy to kinetic (velocity) energy, and the suction chamber/diffuser section where the entrainment and mixing take place. Eductors are reliable, usually requiring no seals or packing, they have no moving parts and they are generally maintenance-free.

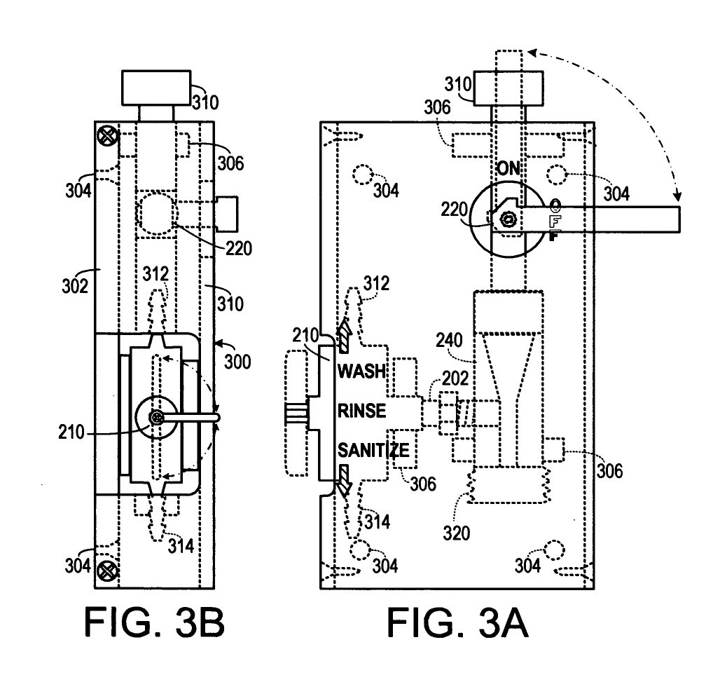

As shown in FIGS. 3A and 3B, the cutoff intake port 222 is coupled to a female-type hose connector 310 and the eductor discharge port is coupled to a male-type hose connector 320 to facilitate connection to a hose. Also, the first intake port terminates in a tube connector 312 and, similarly, the second intake port terminates in a tube connector 314, to facilitate connection of intake tubes to the intake ports.

The three-way valve 210, the check valve 202, the eductor 240 and the cut-off valve 220 may all be encased in a housing 300. The housing 300 may include a platform 302 to which the system is affixed and a protective shield 310 that covers 310 the system. The platform 302 and the protective shield 310 may be made of a substantially transparent material, such as sheet acrylic or a polycarbonate. These devices may be secured to the platform using pipe clamps 306. One illustrative example of such a clamp is the Touchdown Universal Pipe Clamp available from Sioux Chief Manufacturing Company, Peculiar, Mo. The platform 302 may include screw holes 304 to facilitate securing to a wall.

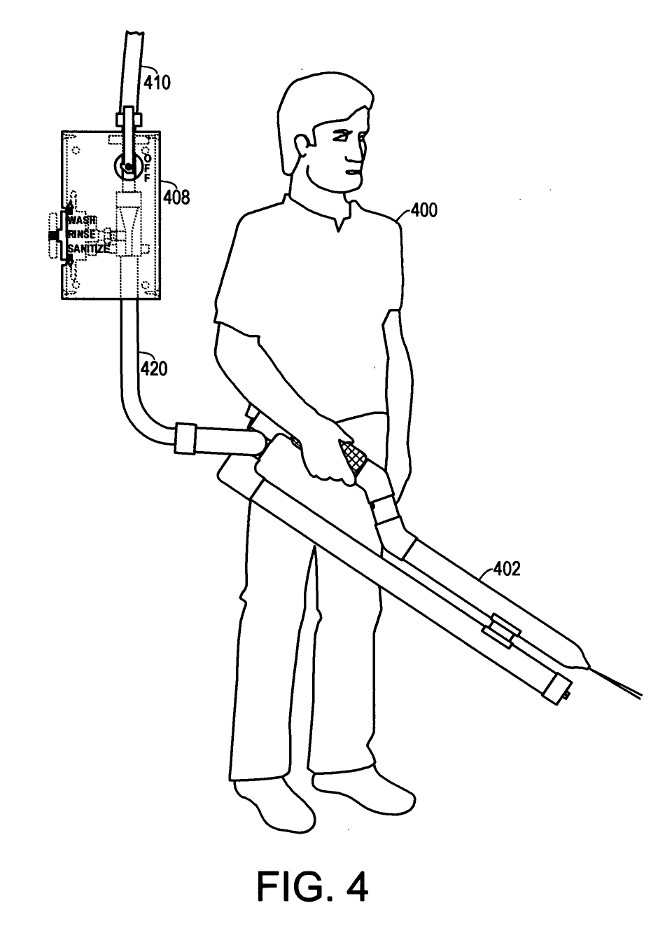

Use of one disclosed embodiment is shown in FIG. 4, in which a user 400 is using a proportioning system 408 that is connected to a water source 410 and a discharge hose 420. The discharge hose is connected to a sprayer system 402. The configuration shown could be employed in a cleaning system for cleaning floors, such as a floor used in a food processing facility.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A proportioning system, comprising:
a. a cutoff valve, having a cutoff intake port and a cutoff discharge port, the cutoff valve capable of receiving a carrier fluid from a carrier fluid source and selectively discharging the carrier fluid through the cutoff discharge port, the cutoff valve also capable of inhibiting carrier fluid flow from the cutoff intake port to the cutoff discharge port;
b. a three-way valve having a first intake port, a second intake port and a first discharge port, the three-way valve capable of receiving a first active fluid through the first intake port and a second active fluid through the second intake port and capable of selectively discharging a selected one of the first active fluid and the second active fluid through the first discharge port, the three-way valve also capable of inhibiting flow from of both the first active fluid and the second active fluid to the first discharge port;
c. a check valve in fluid communication with the first discharge port; and
d. an eductor, having an eductor intake port, an eductor suction port and an eductor discharge port, the eductor suction port in fluid communication with the check valve, the eductor intake port in fluid communication with the cutoff discharge port, the eductor capable of receiving an active fluid from the check valve through the suction port when the carrier fluid is passing from the eductor intake port to the eductor discharge port so as to mix the active fluid with the carrier fluid.

2. The proportioning system of claim 1, wherein the cutoff valve, the three-way valve, the check valve and the eductor are all affixed to a platform.

3. The proportioning system of claim 1, further comprising a protective shield that covers the cutoff valve, the three-way valve, the check valve and the eductor.

4. The proportioning system of claim 3, wherein the protective shield comprises a substantially transparent material.

5. The proportioning system of claim 1, wherein the cutoff valve comprises a ball valve.

6. The proportioning system of claim 1, wherein the cutoff intake port and the eductor discharge port are each coupled to a hose connector for connecting to a hose.

7. The proportioning system of claim 6, wherein the hose connector coupled to the cutoff intake port comprises a female-type connector.

8. The proportioning system of claim 6, wherein the hose connector coupled to the eductor discharge port comprises a male-type connector.

9. The proportioning system of claim 1, wherein the first intake port and the second intake port each terminate in a tube connector.

10. A proportioning system, comprising:
a. a three-way valve having a first intake port, a second intake port and a first discharge port, the three-way valve capable of receiving a first active fluid through the first intake port and a second active fluid through the second intake port and capable of selectively discharging a selected one of the first active fluid and the second active fluid through the first discharge port, the three-way valve also capable of inhibiting flow from of both the first active fluid and the second active fluid to the first discharge port; and
b. an eductor, having an eductor intake port, an eductor suction port and an eductor discharge port, the eductor suction port in fluid communication with the first discharge port of the three-way valve, the eductor intake port in fluid communication with a fluid source, the eductor capable of receiving an active fluid from the check valve through the suction port when the carrier fluid is passing from the eductor intake port to the eductor discharge port so as to mix the active fluid with the carrier fluid.

11. The proportioning system of claim 10, further comprising a check valve disposed between the eductor and the three-way valve.

12. The proportioning system of claim 10, wherein the cutoff valve, the three-way valve and the eductor are all affixed to a platform.

13. The proportioning system of claim 10, further comprising a protective shield that covers the three-way valve and the eductor.

14. The proportioning system of claim 13, wherein the protective shield comprises a substantially transparent material.

15. The proportioning system of claim 10, wherein the first intake port and the second intake port each terminate in a tube connector.

16. A method of proportioning fluids, comprising the steps of:
a. fluidly coupling a selected one of a first active fluid source and a second active fluid source to a first discharge port;
b. educting the selected one of the first active fluid and the second active fluid into a stream of a carrier fluid so as to cause mixing of the carrier fluid and the selected one of the first active fluid and the second active fluid, thereby forming a mixed fluid; and
c. discharging the mixed fluid.

17. The method of claim 16, wherein the first active fluid comprises a cleaning solution.

18. The method of claim 16, wherein the second active fluid comprises a sanitizing solution.

19. The method of claim 16, wherein the carrier fluid comprises water.
